(19) United States
(12) Patent Application Publication
(10) Pub. No.: US 2010/0315811 A1
(43) Pub. Date: Dec. 16, 2010

(54) CURVED LIGHT GUIDING ILLUMINATOR

(76) Inventors: Shih-Chou CHEN, Hsinchu Industrial Park (TW); Zhi-Zhong CHEN, Hsinchu Industrial Park (TW); Hung-Chang LAN, Hsinchu Industrial Park (TW); Ching-Tai HSU, Hsinchu Industrial Park (TW)

Correspondence Address: Muncy, Geissler, Olds & Lowe, PLLC, 4000 Legato Road, Suite 310, FAIRFAX, VA, 22033, US

(21) Appl. No.: 12/482,200

(22) Filed: Jun. 10, 2009

(51) Int. Cl. F21V 1/00

(52) U.S. Cl. 362/235

(57) ABSTRACT

A curved light guiding illuminator includes primarily a curved light guide plate, a diffuser plate and a reflector. At least one edge of the curved light guide plate has plural light emitting elements, and one side of the curved light guide plate is a rough surface to change a light path. Therefore, the path of light generated by the light emitting elements at one edge of the light guide plate is changed by being reflected through the rough surface inside the light guide plate, and a wider area of irradiation is provided.

### BACKGROUND OF THE INVENTION

a) Field of the Invention

The present invention relates to a light guide plate, and more particularly to a curved light guiding illuminator which can largely increase entire illumination brightness and range.

b) Description of the Prior Art

Referring to FIG. 1, it shows a conventional direct-type light guide plate. As shown in the drawing, this illumination device 1 is constituted by a diffuser plate 10, a circuit board 12 and light emitting diodes 14, wherein the circuit board 12 is provided with the plural light emitting diodes 14, and the diffuser plate 10 is installed at a location facing toward the light emitting diodes 14. Hence, light which emits from the light emitting diodes 14 will directly irradiate on the diffuser plate 10 and will be guided outside to achieve an illuminating effect. If brightness needs to be increased, then it needs to replace with another circuit board having more light emitting diodes 14 that an effect of high illumination can be achieved.

However, upon using the aforementioned direct-type light guide plate, following issues and shortcomings actually exist for improvement:
1. A number of the light emitting diodes 14 for this kind of structure will affect the entire luminance.
2. As this illumination structure is a direct-type illuminator, if the light emitting diodes 14 are not placed symmetrically or uniformly, then non-uniform light will be resulted, wherein a user will see plural LED (Light Emitting Diode) light dots with lower brightness between the LEDs, thereby forming non-uniform light.
3. As the light emitting diodes 14 emit direct-type light, an area on which light irradiates is smaller relatively, and therefore, a range of illumination cannot be improved.

Accordingly, how to solve the aforementioned issues and shortcomings for the prior art is to be studied and researched for improvement by the present inventor and related vendors.

### SUMMARY OF THE INVENTION

The primary object of the present invention is to provide a curved light guiding illuminator which is primarily assembled by a curved light guide plate, a diffuser plate and a reflector, wherein at least one end edge of the curved light guide plate is provided with plural light emitting elements, one side of the curved light guide plate is formed with a rough surface to change a light path, and an exterior side of the curved light guide plate is formed with plural V-shape grooves. Hence, when a reflection layer which covers on an inner surface of the curved light guide plate is impinged by light from the light emitting elements, the light path can be changed by a rough reflection region, allowing the reflected light to emit out through a surface of the reflection region, so as to provide a wider area of irradiation. Furthermore, by using the V-shape grooves, light is reflected onto the diffuser plate on the exterior side of the curved light guide plate, which increases a diffusion angle of the light after being reflected, so as to provide an even wider area of irradiation.

Another object of the present invention is provide a curved light guiding illuminator, wherein as the curve is used to increase a range of illumination, fewest light emitting diodes (LEDs) can be utilized to achieve a largest illumination effect.

Still another object of the present invention is to provide a curved light guiding illuminator, wherein by using the reflection region, light of the LEDs can be distributed uniformly, thereby improving luminance.

Yet still another object of the present invention is to provide a curved light guiding illuminator, wherein a light path is changed as density of the reflection region increases gradually, which in turn controls illumination brightness and angle.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional direct-type light guide plate.

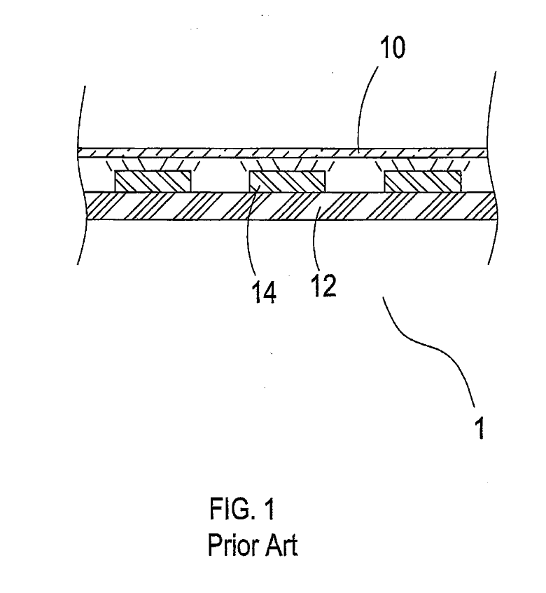

FIG. 2 shows a three-dimensional schematic view of a curved light guide plate, two end edges of which are provided with plural LEDs, according to the present invention.

FIG. 2A shows a three-dimensional exploded view of FIG. 2.

FIG. 3 shows a schematic view of a light path of the structure in FIG. 2.

FIG. 4 shows a three-dimensional schematic view of another embodiment of a curved light guide plate, two ends of which are provided with LEDs and an exterior side of which is installed with a diffuser plate, according to the present invention.

FIG. 5 shows a schematic of a light path of the structure in FIG. 4.

FIG. 6 shows a structural schematic view of still another embodiment of a curved light guide plate, an exterior side of which is provided with V-shape grooves, according to the present invention.

FIG. 7 shows a three-dimensional schematic view of the curved light guide plate in FIG. 6, with the exterior side of the light guide plate being provided with the V-shape grooves.

FIG. 8 shows a structural schematic view of the curved light guide plate in FIG. 7, with positions of the V-shape grooves being changed.

### DETAILED DESCRIPTION OF THE PREFERRED EMBODIMENTS

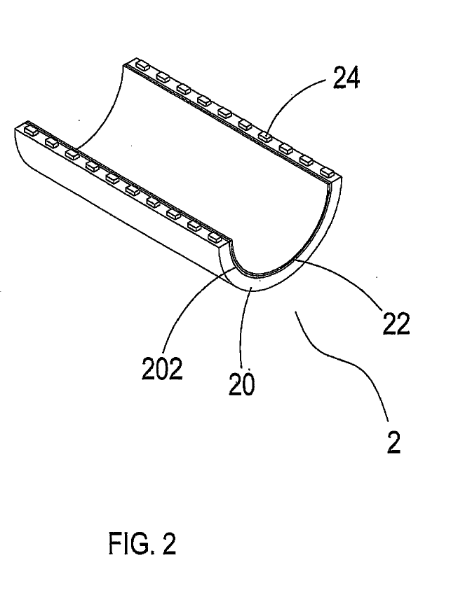

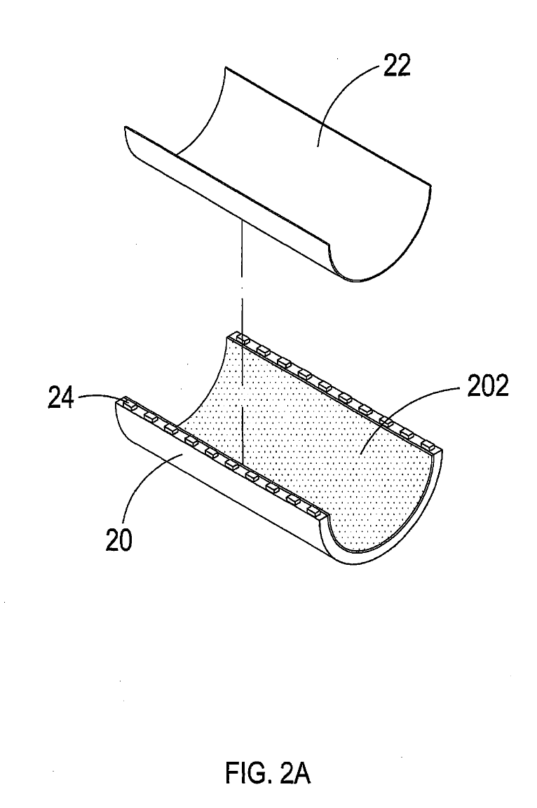

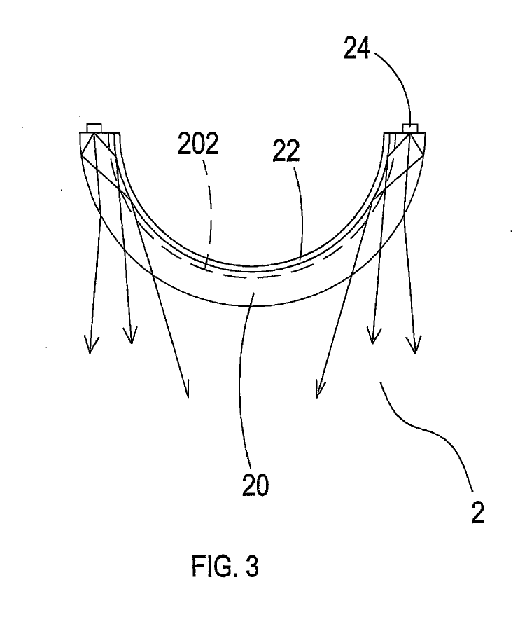

Referring to FIGS. 2, 2A and 3, it shows a three-dimensional schematic view of a curved light guide plate, two end edges of which are provided with plural LEDs, a three-dimensional exploded view of FIG. 2 and a schematic view of a light path of the structure in FIG. 2, according to the present invention. As shown in the drawings, the present invention is a curved light guiding illuminator. This light guiding structure 2 comprises primarily a curved light guide plate 20 (e.g., transparent or semi-transparent) and a reflection layer 22 (e.g., a reflector), wherein two end edges of the curved light guide plate 20 are provided with plural light emitting elements 24 (LEDs) and one side of the curved light guide plate 20 is formed with a reflection region 202 (such as a rough surface, a sunk spot or mesh region) to change a light path. In addition, the reflection region 202, which is on an inner surface of the curved light guide plate 20, is covered with the reflection layer 22 to reflect light, and the reflection layer 22 is a thin-type metallic reflection layer formed by a vapor deposition or sputtering coating process. Accordingly, when the light emitting elements 24 illuminate, a light path will be changed following gradual increase of density of the reflection region 202 on the inner surface of the curved light guide plate 20, so as to control illumination brightness and angle. Furthermore, reflectivity of entire light is improved by the reflection layer 22, which increases light and improves luminance, thereby achieving a largest illumination effect.

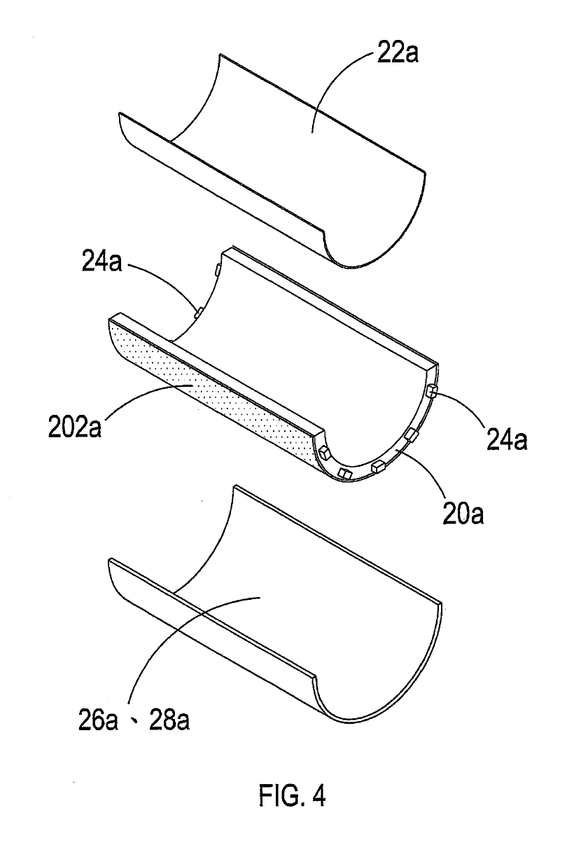

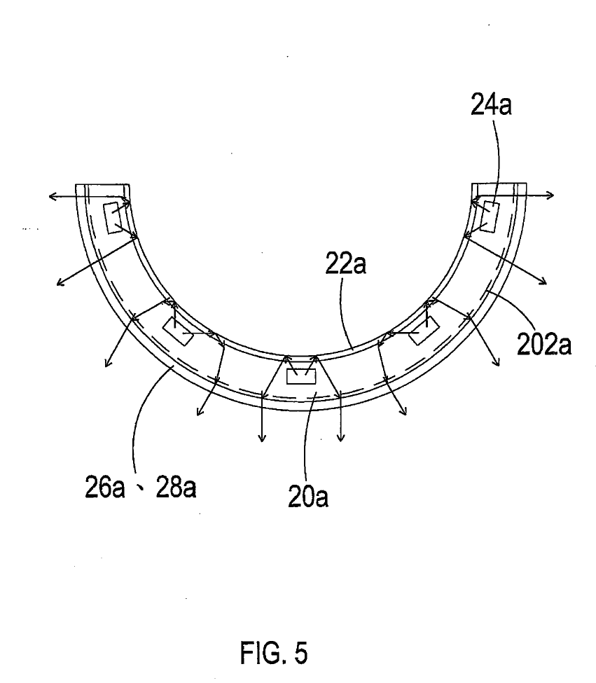

Referring to FIG. 4 and FIG. 5, it shows a three-dimensional schematic view of another embodiment of a curved light guide plate, an exterior side of which being provided with a diffuser plate, and a schematic view of a light path of the structure in FIG. 4, according to the present invention. As shown in the drawings, light emitting elements 24a are provided at two end edges of a curved light guide plate 20a. When the light emitting elements 24a illuminate, a light path will be changed following gradual increase of density of a reflection region 202a at one side of the curved light guide plate 20a, so as to control illumination brightness and angle. On the other hand, reflectivity of entire light is improved by a reflection layer 22a, which increases light and improves luminance.

Moreover, an exterior side of the curved light guide plate 20a is covered with a diffuser plate 26a or a lens 28a, wherein the present embodiment uses the diffuser plate 26a. Light after reflection will be refracted onto the diffuser plate 26a through the curved light guide plate 20a, so as to increase a range of irradiation by the diffuser plate 26a. Whereas, transmittance of the aforementioned curved light guide plate 20a determines how much light can irradiate, in order to control a gray level. Thus, by using the diffuser plate 26a, a range of illumination can be increased. Therefore, fewest light emitting elements 24a (LEDs) can be utilized to achieve a maximum illumination effect. On the other hand, by the reflection region on the inner surface of the curved light guide plate 20a, light of the light emitting elements 24a can be distributed uniformly, thereby improving the luminance.

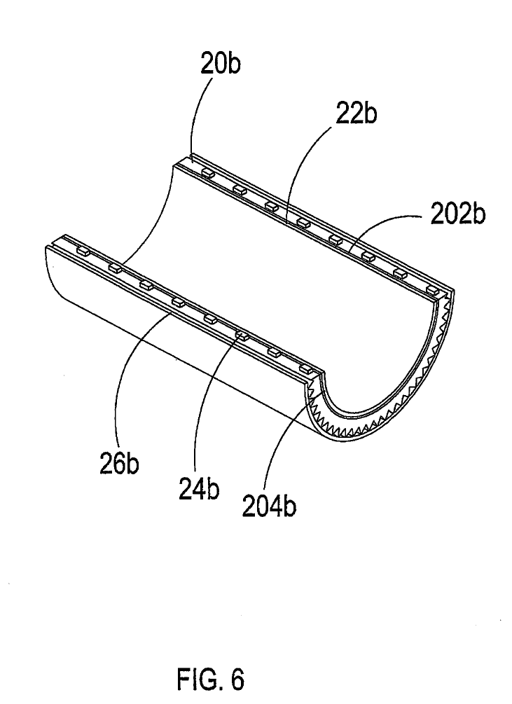

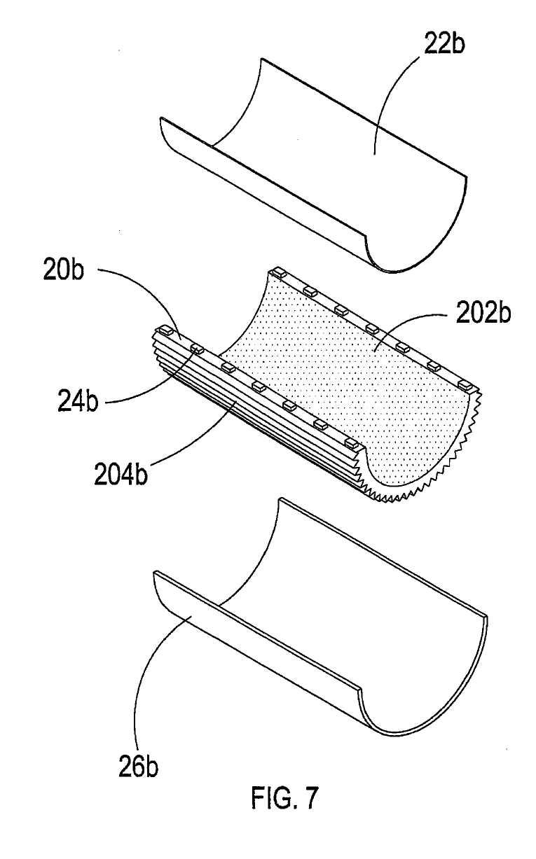

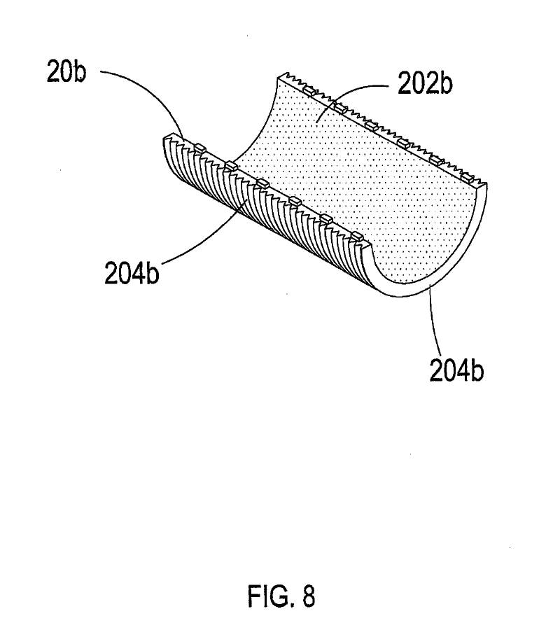

Referring to FIGS. 6 to 8, it shows a structural schematic view of still another embodiment of a curved light guide plate, an exterior side of which being provided with V-shape grooves, a three-dimensional schematic view of the curved light guide plate in FIG. 6, the exterior side of which being provided with the V-shape grooves, and a structural schematic view of the curved light guide plate in FIG. 7, with positions of the V-shape grooves being changed, according to the present invention. As shown in the drawings, an exterior side of a curved light guide plate 20b is formed longitudinally or transversally with plural V-shape grooves 204b. When light emitting elements 24b at one end edge of the curved light guide plate 20b illuminate, a light path will be changed following gradual increase of density of a reflection region 202b on an inner surface of the curved light guide plate 20b, so as to control illumination brightness and angle. On the other hand, by a reflection layer 22b, reflectivity of entire light can be increased, thereby increasing light to improve the luminance.

Light after reflection will be reflected once more using the V-shape grooves 204b on the exterior side of the curved light guide plate 20b to increase the luminance further. In addition, light after reflection is impinged onto a diffuser plate 26b, increasing a range of irradiation by the diffuser plate 26b. Whereas, transmittance of the aforementioned curved light guide plate 20b determines how much light can irradiate, in order to control a gray level. Accordingly, by using the diffuser plate 26b, the range of illumination can be increased. Hence, fewest light emitting elements 24b (LEDs) can be utilized to achieve the largest illumination effect. Moreover, by the reflection region on the inner surface of the curved light guide plate 20b, light of the light emitting elements 24b can be distributed uniformly, thereby improving the luminance.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A curved light guiding illuminator comprising a curved light guide plate, an end edge of which is provided with plural light emitting elements and one side of which is formed with a reflection region to change a light path; and a reflection layer which covers on one side of the curved light guide plate to provide reflection light.

2. The curved light guiding illuminator according to claim 1, wherein an end edge opposite to the end edge of the curved light guide plate is provided with plural light emitting elements.

3. The curved light guiding illuminator according to claim 1, wherein an exterior side of the curved light guide plate is formed with plural V-shape grooves.

4. The curved light guiding illuminator according to claim 1, wherein the light emitting elements are light emitting diodes.

5. The curved light guiding illuminator according to claim 2, wherein the light emitting elements are light emitting diodes.

6. The curved light guiding illuminator according to claim 1, wherein the reflection region is further a rough surface, a sunk spot region or a mesh region.

7. The curved light guiding illuminator according to claim 1, wherein the curved light guide plate is transparent or semi-transparent.

8. The curved light guiding illuminator according to claim 1, wherein an exterior side of the curved light guide plate is covered with a diffuser plate.

9. The curved light guiding illuminator according to claim 1, wherein an exterior side of the curved light guide plate is covered with a lens.

10. The curved light guiding illuminator according to claim 1, wherein the reflection layer is a reflector and directly covers on one side of the curved light guide plate.

11. The curved light guiding illuminator according to claim 1, wherein the reflection layer is a thin-type metallic reflection layer which is formed on one side of the curved light guide plate by a vapor deposition or a sputtering coating process.
